(19) United States
(12) Patent Application Publication
(10) Pub. No.: US 2022/0050183 A1
(43) Pub. Date: Feb. 17, 2022

(54) INTERTWINED DETECTOR ARRAY FOR AN OPTICAL SENSING SYSTEM

(71) Applicant: BEIJING VOYAGER TECHNOLOGY CO., LTD., Beijing (CN)

(72) Inventors: Qin ZHOU, Mountain View, CA (US); Youmin Wang, Mountain View, CA (US); Yue Lu, Mountain View, CA (US)

(73) Assignee: BEIJING VOYAGER TECHNOLOGY CO., LTD., Beijing (CN)

(21) Appl. No.: 16/992,030

(22) Filed: Aug. 12, 2020

(51) Int. Cl. G01S 7/4863; G01S 7/481; G01S 17/931

(52) U.S. Cl. CPC G01S 7/4863; G01S 17/931; G01S 7/4817; G01S 7/4816

(57) ABSTRACT

Embodiments of the disclosure provide systems and methods for reflecting optical signals in an optical sensing system. An exemplary receiver of the optical sensing system includes a detector array configured to detect the optical signals. The detector array includes a plurality of intertwined detectors arranged to each cover a scanning range in a first direction. The scanning range covered by each detector among the plurality of intertwined detectors partially overlaps with the scanning range covered by at least one of its neighboring detectors. The receiver also includes a controller operatively coupled to the detector array, configured to process the optical signals detected by the detector array.

### TECHNICAL FIELD

The present disclosure relates to optical sensing systems such as a light detection and ranging (LiDAR) system, and more particularly to, an intertwined detector array for the optical sensing system.

### BACKGROUND

Optical sensing systems such as LiDAR systems have been widely used in advanced navigation technologies, such as to aid autonomous driving or to generate high-definition maps. For example, a typical LiDAR system measures the distance to a target by illuminating the target with pulsed laser light beams and measuring the reflected pulses with a sensor such as a photodetector or a photodetector array. Differences in laser light return times, wavelengths, and/or phases can then be used to construct digital three-dimensional (3D) representations of the target. Because using a narrow laser beam as the incident light can map physical features with very high resolution, a LiDAR system is particularly suitable for applications such as sensing in autonomous driving and high-definition map surveys.

The pulsed laser light beams emitted by a LiDAR system are typically directed to multiple directions to scan a 2-dimension pattern (e.g., a field of view (FOV)). For example, a scanner of the LiDAR system may scan a certain scanning range in a first dimension and the LiDAR system may rotate in a second dimension, perpendicular to the first dimension, to cover the FOV. The pulsed laser light beams reflected by an object within the FOV are typically received and detected by a detector array that includes multiple detectors. Each detector within the detector array may be configured to detect emitted light beams within a certain scanning range in the first dimension.

Because of the manufacturing constrains such as the semiconductor processing and fabricating limitations, detectors in the detector array are separated with a significant gap in between. As a result, the light spot formed by the returned light beam may be received by the gap area in between detectors instead of a detector. Accordingly, the optical signal received (e.g., energy of the received photons) can be very weak or entirely missing. As a result, the detecting result of the FOV may show an obvious uneven pattern (e.g., a few dark lines after several lines of normal scanning result) because of the gap. This may significantly reduce the precision and accuracy of the detecting result.

### SUMMARY

Embodiments of the disclosure provide a receiver of a Light Detection and Ranging (LiDAR) system for detecting optical signals reflected by an object. The receiver includes a detector array configured to detect the optical signals. The detector array includes a plurality of intertwined detectors arranged to each cover a scanning range in a first direction. The scanning range covered by each detector among the plurality of intertwined detectors partially overlaps with the scanning range covered by at least one of its neighboring detectors. The receiver also includes a controller operatively coupled to the detector array, configured to process the optical signals detected by the detector array.

Embodiments of the disclosure also provide a method for detecting optical signals reflected by an object. The method includes detecting a first optical signal by a first pair of neighboring detectors in a detector array. The detector array includes a plurality of intertwined detectors arranged to each cover a scanning range in a first direction. The scanning range covered by each detector among the plurality of intertwined detectors partially overlaps with the scanning range covered by at least one of its neighboring detectors. The method also includes detecting a second optical signal by a second pair of neighboring detectors in the detector array. The method further includes processing, by a controller operatively coupled to the detector array, the first and second optical signals detected by the first and second pairs of detectors.

Embodiments of the disclosure further provide an optical sensing system. The system includes a transmitter configured to emit optical signals steered to scan an object. The system further includes a receiver including a detector array configured to detect the optical signals reflected by the object. The detector array includes a plurality of intertwined detectors arranged to each cover a scanning range in a first direction. The scanning range covered by each detector among the plurality of intertwined detectors partially overlaps with the scanning range covered by at least one of its neighboring detectors. The optical sensing system also includes a controller operatively coupled to the receiver, configured to process the optical signals detected by the detector array.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary vehicle equipped with a LiDAR system, according to embodiments of the disclosure.

FIG. 2 illustrates a block diagram of an exemplary LiDAR system, according to embodiments of the disclosure.

FIG. 3A illustrates a schematic diagram of an exemplary detector array of FIG. 2 for detecting a returned laser beam reflected by an object, according to embodiments of the disclosure.

FIG. 3B illustrates a schematic diagram of another exemplary detector array of FIG. 2 for detecting a returned laser beam reflected by an object, according to embodiments of the disclosure.

FIG. 4 illustrates a flow chart of an exemplary method for detecting optical signals reflected by an object using an intertwined detector array, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

Embodiments of the present disclosure provide systems and methods for detecting optical signals reflected by an object using an optical sensing system (e.g., a LiDAR system). For example, the optical sensing system may include a transmitter configured to emit optical beams (e.g., laser beams) steered to scan an object (e.g., scan a field of view (FOV)). The light beams reflected by the object may be received by a receiver including a detector array. The detector array may include a plurality of intertwined detectors arranged to each cover a scanning range in a first direction. The scanning range covered by each detector among the plurality of intertwined detectors partially overlaps with the scanning range covered by at least one its neighboring detector. Detectors within the detector array are separated with a predetermined gap (e.g., determined based on the manufacturing constrains) non-perpendicular to the first direction.

The optical signals (e.g., pulsed laser light beams) emitted by a LiDAR system are typically directed to multiple directions to scan a 2-dimension FOV. For example, the emitted optical signals may be steered by a scanner to scan a certain scanning range in a first dimension (e.g., a range in angular degrees, such as 20 degrees, 40 degrees, etc.) and the LiDAR system may rotate in a second dimension, perpendicular to the first dimension, to cover the FOV. For example, within the scanning range, several hundred lines (e.g., 200 lines, 300 lines, etc.) can be scanned by the scanner in the first dimension. The scanned lines within the scanning range can be determined based on the resolution of the optical sensing system. For example, the higher the resolution is, the larger the number of scanned lines within the scanning range is.

The emitted optical signals may be reflected by an object within the FOV and be received and detected by a detector array. Each of the detectors within the detector array may be configured to cover/receive emitted optical signals within a certain scanning range in the first dimension. For example, if the number of detectors in the detector array is 32, and the scanning range for the transmitter is 20 degree, each detector within the detector array is configured to cover about a 0.625-degree scanning range in the first dimension.

Before being detected by each detector of the detector array, the reflected optical signal may be focused by a lens into an ellipse shape with a major axis in the second dimension. In conventional detector arrays, when the focused optical signal hits the gap between the detectors, a significantly reduced signal intensity may be detected. This may cause uneven scanning pattern in the detecting result.

To reduce the uneven scanning pattern in the detecting result caused by the gap, each of the detectors may be designed such that the covered scanning range of the respective detector overlaps with the scanning range covered by one of its neighboring detector, such that no optical signal is received entirely by the gap area in between the detectors. For one example, a light sensitive area of each detector may be fabricated to have a Z-shape sideway to the first direction and neighboring detectors are arrange in an intertwined fashion. An end arm of the Z-shaped light sensitive area may overlap in scanning range with an end arm of a neighboring detector in the first dimension. Accordingly, the predetermined gap between the detectors may also be in a Z-shape as well (will be disclosed in detail below). As a result, the focused optical signal may always be partially received by a pair of neighboring detectors of the detector array, instead of falling entirely within the gap area. Thus, the uneven scanning pattern in the detecting result caused by the gap can be effectively reduced and the accuracy of the detecting result can be significantly improved.

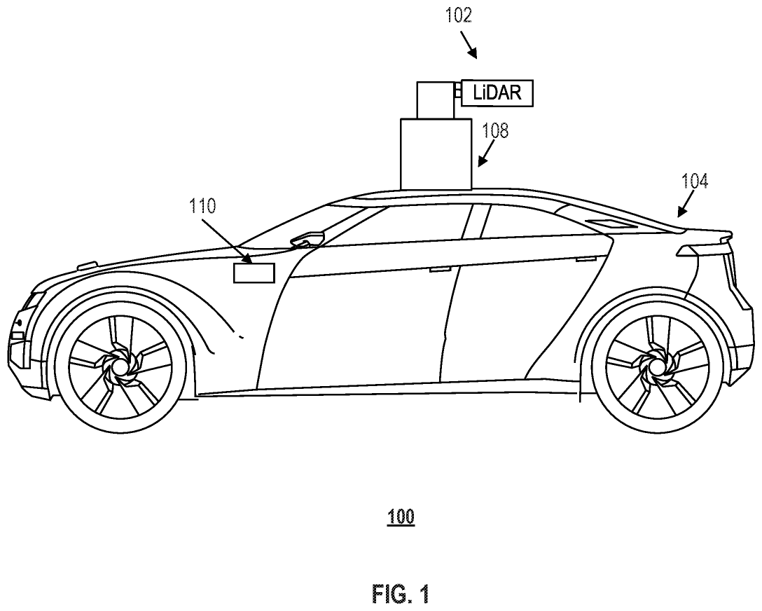

FIG. 1 illustrates a schematic diagram of an exemplary vehicle 100 equipped with an optical sensing system, e.g., a LiDAR system 102, according to embodiments of the disclosure. Consistent with some embodiments, vehicle 100 may be a survey vehicle configured for acquiring data for constructing a high-definition map or 3-D buildings and city modeling. Vehicle 100 may also be an autonomous driving vehicle.

As illustrated in FIG. 1, vehicle 100 may be equipped with LiDAR system 102 mounted to a body 104 via a mounting structure 108. Mounting structure 108 may be an electro-mechanical device installed or otherwise attached to body 104 of vehicle 100. In some embodiments of the present disclosure, mounting structure 108 may use screws, adhesives, or another mounting mechanism. Vehicle 100 may be additionally equipped with a sensor 110 inside or outside body 104 using any suitable mounting mechanisms. Sensor 110 may include sensors used in a navigation unit, such as a Global Positioning System (GPS) receiver and one or more Inertial Measurement Unit (IMU) sensors. It is contemplated that the manners in which LiDAR system 102 or sensor 110 can be equipped on vehicle 100 are not limited by the example shown in FIG. 1 and may be modified depending on the types of LiDAR system 102 and sensor 110 and/or vehicle 100 to achieve desirable 3D sensing performance.

Consistent with some embodiments, LiDAR system 102 and sensor 110 may be configured to capture data as vehicle 100 moves along a trajectory. For example, a transmitter of LiDAR system 102 may be configured to scan the surrounding environment. LiDAR system 102 measures distance to a target by illuminating the target with pulsed laser beam and measuring the reflected pulses with a receiver. The laser beam used for LiDAR system 102 may be ultraviolet, visible, or near infrared. In some embodiments of the present disclosure, LiDAR system 102 may capture point clouds including depth information of the objects in the surrounding environment. As vehicle 100 moves along the trajectory, LiDAR system 102 may continuously capture data.

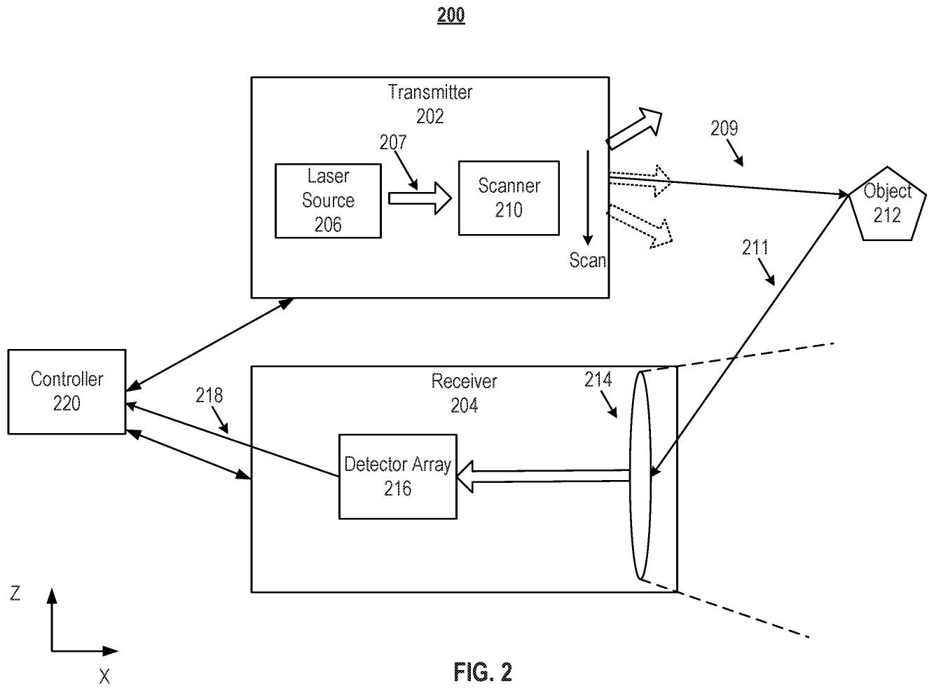

FIG. 2 illustrates a block diagram of an exemplary LiDAR system 102, according to embodiments of the disclosure. LiDAR system 102 may include a transmitter 202 and a receiver 204. Transmitter 202 may emit laser beams along multiple directions. Transmitter 202 may include one or more laser sources 206 and a scanner 210.

Laser source 206 may be configured to provide a laser beam 207 (also referred to as “native laser beam”) to scanner 210. In some embodiments of the present disclosure, laser source 206 may generate a pulsed laser beam in the ultraviolet, visible, or near infrared wavelength range. In some embodiments of the present disclosure, laser source 206 may include a pulsed laser diode (PLD), a vertical-cavity surface-emitting laser (VCSEL), a fiber laser, etc. For example, a PLD may be a semiconductor device similar to a light-emitting diode (LED) in which the laser beam is created at the diode's junction.

Scanner 210 may be configured to steer a laser beam 209 in the first direction (e.g., along Z axis) to scan an object 212. Scanner 210 may include mirror assembly configured to steer the emitted laser beams in different directions within the scanning range (e.g., a range in angular degrees, such as 20 degrees, 40 degrees, etc.), as illustrated in FIG. 2. Object 212 may be made of a wide range of materials including, for example, non-metallic objects, rocks, rain, chemical compounds, aerosols, clouds and even single molecules. The wavelength of laser beam 209 may vary based on the composition of object 212.

In some embodiments, at each time point during the scan, scanner 210 may steer laser beam 209 to object 212 in a direction within a range of scanning angles by rotating the mirror assembly. In some embodiments of the present disclosure, scanner 210 may also include optical components (e.g., lenses, mirrors) that can focus pulsed laser light into a narrow laser beam to increase the scan resolution and the scanning range to scan object 212.

In some embodiments, as will be described below in detail, receiver 204 may include an intertwined detector array for detecting a returned laser beam 211 returned from object 212. Returned laser beam 211 may be in a different direction from laser beam 209. Receiver 204 can collect laser beams returned from object 212 and output electrical signals reflecting the intensity of the returned laser beams. Upon contact, laser light can be reflected by object 212 via backscattering, such as Rayleigh scattering, Mie scattering, Raman scattering, and fluorescence.

As illustrated in FIG. 2, receiver 204 may include a lens 214 and a detector array 216. Lens 214 may be configured to collect light (e.g., the optical signals) from a respective direction in its FOV and focus each optical signal to a light spot before being detected by detector array 216. At each time point during the scan, returned laser beam 211 may be collected by lens 214. Returned laser beam 211 may be returned from object 212 and have the same wavelength as laser beam 209.

Detector array 216 may include a plurality of intertwined detectors and may be configured to detect returned laser beam 211 returned from object 212. In some embodiments, each detector of detector array 216 may include at least one of a photo detector (PD), an avalanche photodiode (APD) or a single-photon avalanche diode (SPAD). In some embodiments, each detector of detector array 216 may convert the optical signal (e.g., returned laser beam 211) within a certain scanning range in the first direction (e.g., Z axis in FIG. 2) collected by lens 214 into an electrical signal 218 (e.g., a current or a voltage signal). Electrical signal 218 may be generated when photons are absorbed by a light sensitive area included in each detector of detector array 216.

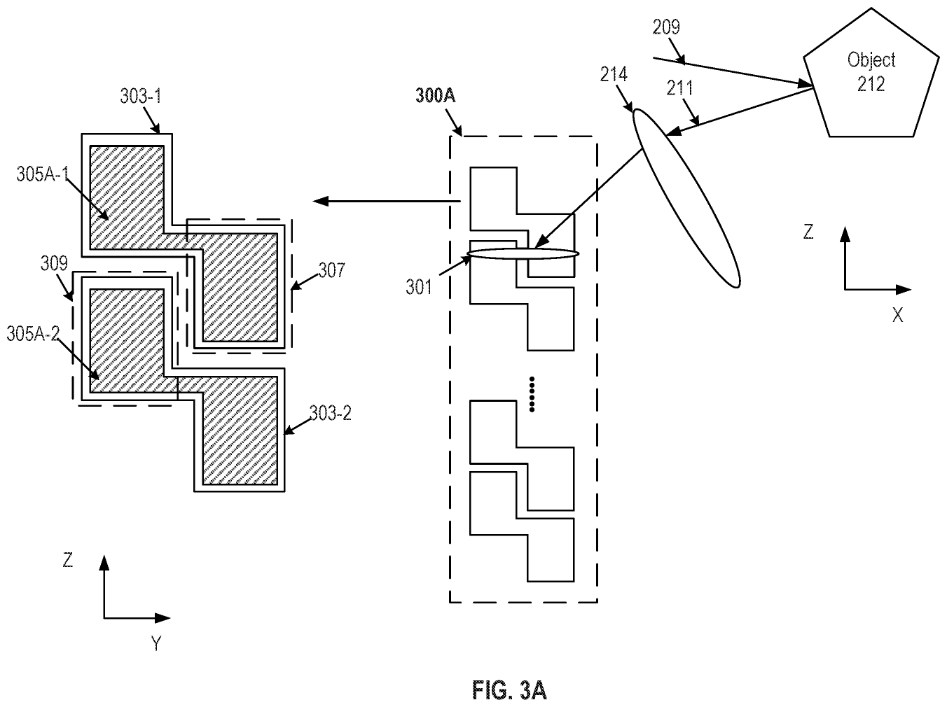

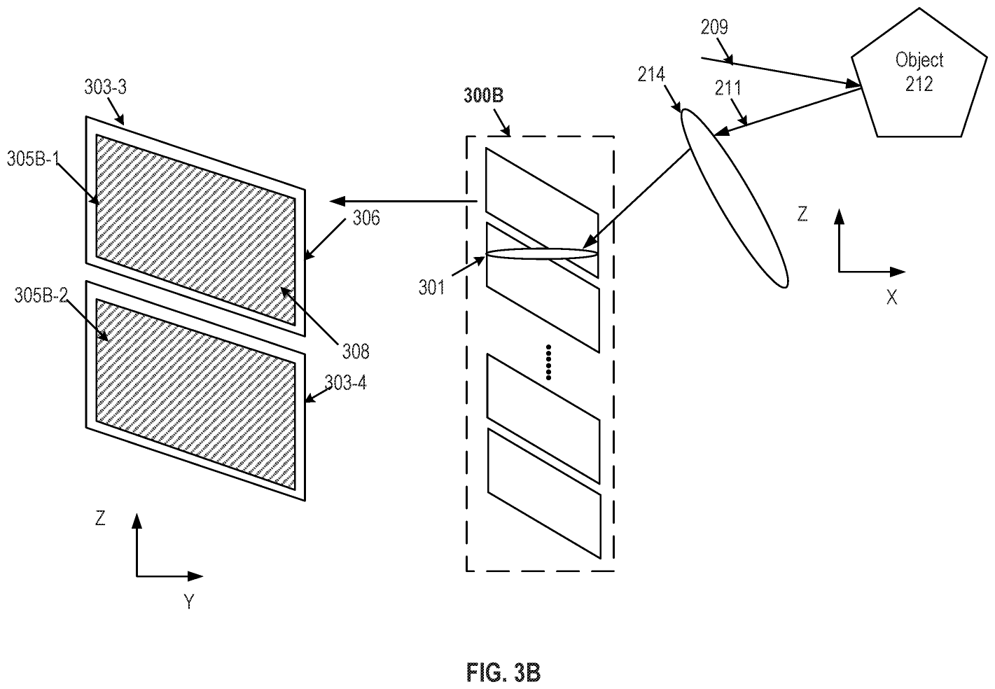

Consistent with the present disclosure, and as will be described in more details below in connection with FIGS. 3A and 3B, detector array 216 may include multiple detectors separated by a gap in between. The detectors may be arranged in an intertwined manner such that each of the detectors covers a scanning range overlapping with the scanning range covered by one or both of its neighboring detector. Due to the intertwined nature of the detector pattern, the focused optical signal may always be partially received by a pair of neighboring detectors of the detector array, instead of falling entirely within a gap area in between the detectors. Each detector may have a light sensitive area formed by doping, and the sensitive area may have a shape that does not coincide with the focused light spot. For one example, the light sensitive area may be fabricated to have a Z-shape sideway to the Z axis (e.g., shown in FIG. 3A), and an end arm of the Z-shaped light sensitive area may overlap in scanning range with an end arm of a neighboring detector in the first dimension. For another example, the light sensitive area may form an oblique parallelogram (e.g., shown in FIG. 3B), where one side of the parallelogram is parallel to the Z axis and the adjacent side is oblique. Accordingly, the gap area is an oblique stripe non-perpendicular with the Z axis, and no light spot will fall entirely in the gap area. The intertwined detector array can effectively reduce the uneven scanning pattern in the detecting result caused by the gap and improve the accuracy of the detecting result can be significantly improved.

LiDAR system 200 may further include one or more controllers, such as a controller 220. Controller 220 may control the operation of transmitter 202 and/or receiver 204 to perform detection/sensing operations. Specifically, controller 220 may control the scanning of transmitter 202 and may control the receiver 204 to receive the optical signals. Controller 220 may also be configured to process the optical signals received accordingly. For example, controller 220 may individually address the optical signals received by each detector of detector array 216 based on electrical signals 218 corresponding to each of the optical signals.

In some embodiments, controller 220 may include components (not shown) such as a communication interface, a processor, a memory, and a storage for performing various control functions. In some embodiments, controller 220 may have different modules in a single device, such as an integrated circuit (IC) chip (implemented as, for example, an application-specific integrated circuit (ASIC) or a field-programmable gate array (FPGA)), or separate devices with dedicated functions. In some embodiments, the processing module for processing the optical signal received by respective detector of detector array 216 may be disposed on a same microchip with the respective detector. In some other embodiments, the processing module may be disposed on a chip separate from the microchip where the respective detector is disposed on.

In some embodiments, the processor of controller 220 may include any appropriate type of general-purpose or special-purpose microprocessor, digital signal processor, or microcontroller. The memory or storage may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. For example, the memory and/or the storage may be configured to store program(s) that may be executed by the processor to control the operation of scanner 210.

FIG. 3A illustrates a schematic diagram of an exemplary detector array 300A for detecting returned laser beam 211 returned from object 212, according to embodiments of the disclosure. FIG. 3B illustrates a schematic diagram of another exemplary detector array 300B for detecting returned laser beam 211 returned from object 212, according to embodiments of the disclosure. Detector arrays 300A and 300B may respectively correspond to detector array 216 in FIG. 2. It is understood that laser beam 209, returned laser beam 211, object 212, and lens 214 in FIGS. 3A and 3B are not in the same coordinate as shown in FIGS. 3A and 3B.

In both FIGS. 3A and 3B, laser beam 209 (i.e., the emitted optical signal) can be steered to scan object 212. Returned laser beam 211 reflected by object 212 can be detected by detector array 300A. Lens 214 may be disposed in front of detector array 300A or 300B, configured to collect light (e.g., the optical signals) from a respective direction according to its scanning angle and focus the photons to a light spot 301 before being detected by detector array 300A or 300B. In some embodiments, light spot 301 may be in an ellipse shape, the major axis of which is perpendicular to the first direction (e.g., in Y axis).

Different from conventional detector array, detector arrays 300A and 300B include a plurality of intertwined detectors arranged to each cover a scanning range (e.g., a range in angular degrees, such as about 0.625 degrees, about 1.25 degrees, etc.) in a first direction (e.g., along Z axis in FIGS. 3A and 3B), and the scanning range covered by each detector among the plurality of intertwined detectors partially overlaps with the scanning range covered by at least one of its neighboring detectors. Accordingly, all the light spots (e.g., returned optical signals focused by lens 214) can be received/covered by at least one detector in detector array 300A or 300B because of the overlap. As a result, no returned optical signal will be received entirely by the gap between detectors in conventional detector arrays and thus missing from the detection. Thus, the uneven scanning pattern in the detecting result caused by the gap can be greatly reduced and the accuracy of the detecting result can be significantly improved.

In one example, as illustrated in FIG. 3A, detector array 300A may include a plurality of detectors, arranged and intertwined in Z axis. For example, detector array 300A may include 32, 64 or more detectors 303 (e.g., detectors 303-1 and 303-2), each of which is configured to cover returned optical signals (e.g., light spot 301) from certain scanning range.

Different from the conventional detector arrays, the covered scanning rang for detector 303-1 in detector array 300A may partially overlap with the covered scanning rang for a neighboring detector 303-2 in Z axis. In some embodiments, each detector may include a light sensitive area forms a Z-shape sideway to the Z axis. For example, detector 303-1 of detector array 300A may include a light sensitive area 305A-1 in a Z-shape for detecting the returned optical signal (e.g., light spot 301) as shown in FIG. 3A. In some embodiments, light sensitive areas 305A-1 and 305A-2 may be formed/fabricated using a N-type doping or a P-type doping performed on a suitable substrate such as a silicon wafer.

In some embodiments, an end arm 307 of light sensitive area 305A-1 of detector 303-1 may overlap with an end arm 309 of light sensitive area 305A-2 of a neighboring detector 303-2 in Z axis. For example, a lower end of end arm 307 may be lower than an upper end of end arm 309 in Z axis. It is understood that “low”, “up”, “lower”, and “upper” are only for showing the relative spatial relationship. When detector array 300A is disposed upside down the relative spatial relationship can be changed accordingly.

Therefore, a predetermined gap between neighboring detectors 303-1 and 303-2 (e.g., determined based on the fabricating limitations) is non-perpendicular to the Z axis. For example, the gap between neighboring detectors 303A and 303B has a sideway Z-shape as well. As a result, even if light spot 301 partially impinges on the gap area between neighboring detectors 303-1 and 303-2, a majority of light spot 301 may still be detected between light sensitive area 305A-1 of detector 303-1 and light sensitive area 305A-2 of detector 303-1. In some scenarios, light spot 301 may be fully received by the light sensitive area of one detector (e.g., light sensitive area 305A-1 of detector 303-1). In some other cases, light spot 301 may be partially received by light sensitive area 305A-1 of detectors 303-1 and light sensitive area 305A-2 of detector 303-2. In the latter case, although part of light spot 301 may still impinge on the gap area between detectors 303-1 and 303-2, the signal lost in the gap area is insubstantial. This may greatly reduce the uneven pattern in the detecting result caused by the gap and may significantly increase the accuracy of the detecting result generated by detector array 300A.

In some embodiments, the overlap in scanning ranges between the neighboring detectors in detector array 300A of FIG. 3A may be designed to be below a threshold. For example, the scanning range covered by each detector overlaps less than 30% with the scanning range covered by its neighboring detector. By minimize the overlap, it increases the chance that light spot 301 be received fully by one detector. This may increase the detecting efficiency and decrease the fabricating complexity of detector array 300A.

In some embodiments, the light sensitive area of each detector can also be in an oblique parallelogram-shape, where one side of the parallelogram is parallel to the Z axis and the adjacent side is oblique. For example, FIG. 3B illustrates a schematic diagram of an exemplary detector array 300B with each detector having a parallelogram-shaped light sensitive area, according to embodiments of the disclosure.

Different from detector array 300A, light sensitive area (e.g., light sensitive areas 305B-1 and 305B-2) of each detector 303 (e.g., detectors 303-3 and 303-4) in detector array 300B can be in a parallelogram-shape. For example, as illustrated in FIG. 3B, a first side 306 of light sensitive area 305B-1 is parallel to the Z axis and a second side 308 is oblique to first side 306. For example, first side 306 and second side 308 form an oblique angle. With second side 308 being oblique, the lowest vertex of detector 303-3 is lower than the highest vertex of detector 303-4. Therefore, detectors 303-3 and 303-4 overlap in the scanning ranges they cover respectively.

Therefore, the predetermined gap between neighboring detectors 303-3 and 303-4 is non-perpendicular to the Z axis, and thus would not be in parallel with the major axis of light spot 301. In some scenarios, light spot 301 may be fully received by the light sensitive area of one detector (e.g., light sensitive area 305B-1 of detector 303-3). In some other scenarios, light spot 301 may be partially received by light sensitive areas 305B-1 of detector 303-3 and light sensitive areas 305B-2 of detector 303-4. In the latter case, even if light spot 301 partially impinges on the gap area between neighboring detectors 303-3 and 303-4, a majority of light spot 301 is detected by the light sensitive area of at least one detector. This may greatly reduce the uneven pattern in the detecting result caused by the gap and may significantly increase the accuracy of the detecting result generated by detector array 300B.

In some embodiments, the overlap in scanning ranges between the neighboring detectors in detector array 300B of FIG. 3B may be designed to exceed a threshold. For example, the scanning range covered by each detector overlaps more than 50% with the scanning range covered by its neighboring detector. By increase the overlap, it reduces the chance that light spot 301 be received substantially by the gap area.

It is contemplated that the shape of the light sensitive area of each detector is not limited to the examples disclosed herein. The exemplary shapes disclosed herein are only for illustrative purposes. Any other suitable shapes that can be arranged in an intertwined fashion to make the light sensitive areas of neighboring detectors overlap in scanning range in the first direction, can be used.

After being detected, each of the optical signal detected by detector arrays 300A and/or 300B may be transmitted to controller 220 (e.g., after being converted into electrical signals such as electrical signal 218 in FIG. 2) for further processing, such as for range estimation, for generating instructions for autonomous driving or for generating high-definition map(s).

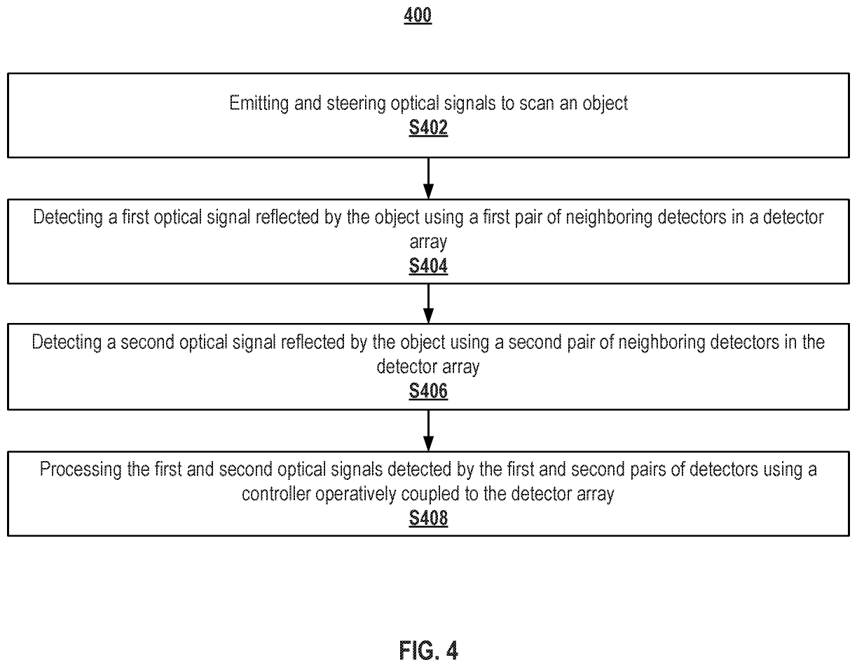

FIG. 4 illustrates a flow chart of an exemplary method 400 for detecting optical signals reflected by an object, according to embodiments of the disclosure. Method 400 may be performed by components such as those disclosed in FIGS. 1, 2, 3A, and 3B. It is understood that the steps shown in method 400 are not exhaustive and that other steps can be performed as well before, after, or between any of the illustrated operations. It is to be appreciated that some of the steps may be optional. Further, some of the steps may be performed simultaneously, or in a different order than shown in FIG. 4.

In step S402, optical signals may be emitted and steered to scan an object by a transmitter (e.g., transmitter 202 in FIG. 2). For example, the transmitter can sequentially emit a stream of pulsed laser beams in different directions within a scanning range (e.g., a range in angular degrees, such as 20 degrees, 40 degrees, etc.) in a first dimension (e.g., along Z axis in FIG. 2), as illustrated in FIG. 2. Within the scanning range, several hundred lines (e.g., 200 lines, 300 lines, etc.) in the first dimension can be scanned. The scanned lines within the scanning range can be determined based on the resolution of the optical sensing system. For example, the higher the resolution is, the larger the number of scanned lines within the scanning range is.

In step S404, a first optical signal reflected by the object (e.g., returned laser beam 211) is detected by a first pair of neighboring detectors (e.g., neighboring detectors shown in FIGS. 3A and 3B) in a detector array (e.g., detector array 300A or 300B). The detector array includes a plurality of intertwined detectors arranged to each cover a scanning range in a first direction (e.g., Z axis in FIGS. 3A and 3B). The scanning range covered by each detector among the plurality of intertwined detectors partially overlaps with the scanning range covered by at least one of its neighboring detectors. For example, as illustrated in FIGS. 3A and 3B, a light sensitive area of each detector overlaps with the light sensitive area of at least one of its neighboring detectors. In some embodiments, the first optical signal may be focused to a first light spot, e.g., by lens 214, before being detected by the first pair of neighboring detectors. The first light spot may be partially received on the detectors of the first pair of neighboring detectors.

In step S406, a second optical signal reflected by the object is detected by a second pair of neighboring detectors in the detector array. For example, the second optical signal may be from a scanning range different from the scanning range covered by the first pair of neighboring detectors. In some embodiments, the second optical signal may be focused to a second light spot, e.g., by lens 214, before being detected by the second pair of neighboring detectors. In some embodiments, the second light spot can be detected by both detectors of the second pair of neighboring detectors.

In step S408, the first and second optical signals detected by the detector array can be processed by a controller (e.g., controller 220 as shown in FIG. 2) operatively coupled to the detector array. For example, the controller may individually address the optical signal detected by each detector of the detector array. In some embodiments, the controller may combine electrical signals received from the respective detectors in the first pair of neighboring detectors to form an electrical signal corresponding to the first optical signal or the second optical signal. The controller may be configured to perform advanced navigation such as generate instructions for autonomous driving, generate high-definition map, etc. based on the processed optical signals.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A receiver of a Light Detection and Ranging (LiDAR) system for detecting optical signals reflected by an object, comprising:
a detector array configured to detect the optical signals, the detector array comprising a plurality of intertwined detectors arranged to each cover a scanning range in a first direction, wherein the scanning range covered by each detector among the plurality of intertwined detectors partially overlaps with the scanning range covered by at least one of its neighboring detectors; and
a controller operatively coupled to the detector array, configured to process the optical signals detected by the detector array.

2. The receiver of claim 1, wherein each detector comprises at least one of a photo detector (PD), an avalanche photodiode (APD) or a single-photon avalanche diode (SPAD).

3. The receiver of claim 1, further comprising a lens configured to focus each optical signal to a light spot before being detected by the detector array.

4. The receiver of claim 3, wherein the light spot is in an elliptical shape.

5. The receiver of claim 3, wherein the light spot is received by two neighboring detectors of the detector array.

6. The receiver of claim 1, wherein each detector comprises a light sensitive area configured to detect the optical signals, formed using a N-type doping or a P-type doping.

7. The receiver of claim 6, wherein the light sensitive area forms a Z-shape sideway to the first direction.

8. The receiver of claim 6, wherein the light sensitive area forms an oblique parallelogram, with a first side parallel to the first direction and a second side oblique to the first side.

9. The receiver of claim 8, wherein the scanning range covered by each detector overlaps more than a predetermined threshold with the scanning range covered by its neighboring detector.

10. The receiver of claim 1, wherein each detector is separated from its neighboring detector by a gap, wherein the gap is non-perpendicular to the first direction.

11. A method for detecting optical signals reflected by an object, comprising:
detecting a first optical signal by a first pair of neighboring detectors in a detector array comprising a plurality of intertwined detectors arranged to each cover a scanning range in a first direction, wherein the scanning range covered by each detector among the plurality of intertwined detectors partially overlaps with the scanning range covered by at least one of its neighboring detectors;
detecting a second optical signal by a second pair of neighboring detectors in the detector array; and
processing, by a controller operatively coupled to the detector array, the first and second optical signals detected by the first and second pairs of detectors.

12. The method of claim 11, wherein detecting the first optical signal further comprises:
focusing the first optical signal to a first light spot before being detected by the first pair of neighboring detectors; and
receiving the first light spot on the first pair of neighboring detectors.

13. The method of claim 12, wherein processing the first optical signal further comprises: combining electrical signals received from the respective detectors in the first pair of neighboring detectors to form an electrical signal corresponding to the first optical signal.

14. The method of claim 11, wherein detecting the first optical signal further comprises receiving the first optical signal on a light sensitive area of each detector in the first pair of neighboring detectors, the light sensitive area being formed using a N-type doping or a P-type doping.

15. The method of claim 14, wherein the light sensitive area forms a Z-shape sideway to the first direction.

16. The method of claim 15, wherein the light sensitive area forms an oblique parallelogram, with a first side parallel to the first direction and a second side oblique to the first side.

17. An optical sensing system, comprising:
a transmitter configured to emit optical signals steered to scan an object;
a receiver, comprising a detector array configured to detect the optical signals reflected by the object, the detector array comprising a plurality of intertwined detectors arranged to each cover a scanning range in a first direction, wherein the scanning range covered by each detector among the plurality of intertwined detectors partially overlaps with the scanning range covered by at least one of its neighboring detectors; and
a controller operatively coupled to the receiver, configured to process the optical signals detected by the detector array.

18. The optical sensing system of claim 17, wherein each detector comprises a light sensitive area configured to detect the optical signals, wherein the light sensitive area forms a Z-shape sideway to the first direction, or an oblique parallelogram with a first side parallel to the first direction and a second side oblique to the first side.

19. The optical sensing system of claim 17, wherein each optical signal is focused to a light spot before being detected by the detector array, wherein the light spot is received by two neighboring detectors of the detector array.

20. The optical sensing system of claim 17, wherein each detector is separated from its neighboring detector by a gap, wherein the gap is non-perpendicular to the first direction.
